(19) United States
(12) Patent Application Publication
(10) Pub. No.: US 2026/0180214 A1
(43) Pub. Date: Jun. 25, 2026

(54) INTERPOSER FOR VERTICALLY MOUNTING A CONNECTOR ON A SUBSTRATE

(71) Applicant: Sandisk Technologies, Inc., Milpitas, CA (US)

(72) Inventors: Sumukh P. Ontimitta, Bengaluru (IN); Jian Yang, Shanghai (CN); Nandha Kumar Mohanraj, Bengaluru (IN); Raghavan Nagarajan, Bengaluru (IN); Vignesh M, Bengaluru (IN); Jayakrishna Karnam, Bangalore (IN)

(21) Appl. No.: 19/170,311

(22) Filed: Apr. 4, 2025

Related U.S. Application Data
(60) Provisional application No. 63/101,197, filed on Dec. 20, 2024.

(51) Int. Cl. H01R 12/71; H01R 12/70

(52) U.S. Cl. CPC H01R 12/716; H01R 12/7052

(57) ABSTRACT

An interposer includes a number of features that electrically and mechanically support a vertical mounted connector. The interposer includes multiple sets of contacts on a top surface. The contacts are arranged and/or adapted to contact respective pins of the connector when the connector is vertically mounted on the interposer. Each contact in each set of contacts is electrically coupled, using a trace, to a respective pad on the bottom surface of the interposer. The contacts, the traces, and the pads are arranged in a fan-out configuration. The interposer also includes a number of securement features that strengthen a mechanical connection between the connector and the interposer.

### CROSS-REFERENCE TO RELATED APPLICATIONS

The present application claims priority to U.S. Provisional Patent Application No. 63/101,197, entitled “Interposer for Vertically Mounting a Connector on a Substrate”, filed Dec. 20, 2024, the entire disclosure of which is hereby incorporated by reference in its entirety.

### BACKGROUND

Electronic devices and computing devices typically have connectors or ports, such as for example, Universal Serial Bus (USB) connectors. These connectors enable various peripheral devices, such as keyboards, mice, flash drives and phones, to interface with the electronic device. The connectors enable data transfer, power delivery, and/or display capabilities.

A connector is typically mounted on a substrate or a printed circuit board (PCB) of the electronic device. For example, a connector can be horizontally mounted on the substrate or vertically mounted on the substrate. Regardless of the orientation of the connector, wires (typically four) extend from pins of the connector and contact various pads on the substrate.

However, as the number of pins within the connector increases, it becomes increasingly difficult to increase and route the number of wires that extend from the pins of the connector. Additionally, when a connector is vertically mounted on the substrate or the PCB and a peripheral device is inserted into the connector, any movement (inadvertent or otherwise) of the peripheral device may cause damage to the connector and/or disrupt signal transmissions thereby rendering the connector inoperable.

Accordingly, it would be beneficial to securely mount a connector to a substrate or a PCB while also supporting an increase in the number of pins of the connector.

### SUMMARY

The present disclosure describes an interposer for supporting a vertically mounted connector on a substrate or a printed circuit board (PCB) of an electronic device. The interposer includes multiple sets of contacts on a top surface. The contacts are arranged and/or adapted to contact respective pins of the connector when the connector is vertically mounted on the interposer. Each contact in each set of contacts is electrically coupled, using a trace, to a respective pad on the bottom surface of the interposer. The contacts, the traces, and the pads are arranged in a fan-out configuration which reduces cross-talk and/or noise.

The interposer also includes a number of securement features that strengthen a mechanical connection between the connector and the interposer. For example, the interposer includes an alignment aperture and a securement aperture which are adapted to receive and secure an alignment prong and a securement prong that extend from a base of the connector. When the connector has been secured to the interposer, the connector and the interposer are surface mounted on a PCB or substrate.

Accordingly, examples of the present disclosure describe an electronic device that includes a substrate, an interposer and a connector. In an example, the interposer is electrically coupled to the substrate and includes a plurality of contacts on a first surface. At least two of the plurality of contacts have a first spacing. The interposer also includes a plurality of pads on a second surface that is opposite the first surface. In an example, at least two of the plurality of pads have a second spacing that is greater than the first spacing. The interposer also includes a plurality of traces. In an example, each trace of the plurality of traces extend between a respective contact of the plurality of contacts and a respective pad of the plurality of pads. The connector is vertically mounted on the interposer and has a plurality of pins. In an example, each pin of the plurality of pins is electrically coupled to a respective contact of the plurality of contacts.

Examples of the present disclosure also describe an interposer for vertically mounting a connector to a substrate. In an example, the interposer includes a first set of contacts on a first surface of the interposer. The first set of contacts are oriented in a first direction. A second set of contacts are also on the first surface of the interposer. The second set of contacts are oriented in a second direction. In an example, the first set of pins and the second set of pins are adapted to contact respective pins of the connector. The interposer also includes a first set of pads on a second surface of the interposer that is opposite the first surface of the interposer. The first set of pads are electrically coupled to the first set of contacts. A second set of pads are also provided on the second surface of the interposer. The second set of pads are electrically coupled to the second set of contacts.

Still other examples describe an electronic device that includes a substrate, a connector support means and a connector means. In an example, the connector support means is electrically coupled to the substrate and includes a first set of contact means arranged at a first location on a first surface of the connector support means. The contact means have a first spacing. A second set of contact means is arranged at a second location on the first surface of the connector support means. The second set of contact means also have the first spacing. The connector support means also includes a first set of connection means that are electrically coupled to the first set of contact means. The first set of connection means have a second spacing that is greater than the first spacing. The connector support means also includes a second set of connection means electrically coupled to the second set of contact means. In an example, the second set of connection means has the second spacing. A connector means is vertically mounted on the connector support means and is electrically coupled to the first set of contact means and the second set of contact means.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is an interposer on which a connector may be vertically mounted according to an example.

FIG. 2 illustrates a connector being vertically mounted to the interposer of FIG. 1 according to an example.

FIG. 3 illustrates the connector of FIG. 2 being vertically mounted to the top surface of the interposer of FIG. 1 according to an example.

FIG. 4 illustrates the connector and interposer of FIG. 3 being surface mounted to a substrate according to an example.

FIG. 5 illustrates an interposer on which a connector may be vertically mounted according to another example.

FIG. 6 illustrates a substrate that is operable to receive the interposer shown and described with respect to FIG. 5 according to an example.

FIG. 7 illustrates the interposer of FIG. 5 being surface mounted to the substrate of FIG. 6 according to an example.

FIG. 8 illustrates a USB Type-C connector according to the various examples described herein.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Connectors or ports, such as Universal Serial Bus (USB) connectors, are typically used to expand the capabilities of an electronic device, provide power to an electronic device and/or enable the transfer of data between the electronic device and a peripheral device (e.g., a flash drive). The connector may be mounted on a substrate or a printed circuit board (PCB) in a variety of different ways.

For example, the connector may be mounted on a top surface of the substrate, a bottom surface of the substrate or be mid-mounted on the substrate (e.g., a hole is provided in the substrate and the connector is provided in the hole). In other examples, the connector is vertically mounted on the substrate such that the connector is perpendicular to a surface of the substrate. However, regardless of the orientation of the connector, wires (typically four) extend from pins of the connector and contact respective pads on the substrate.

Due to advances in technology, the number of pins within the connector is increasing. For example, newer connectors have up to twenty-four (or more) pins. However, as the number of pins within the connector increases, it becomes difficult to connect separate wires to each pin and route the wires to corresponding pads on the substrate. Additionally, when a connector is vertically mounted on the substrate, the connector is more susceptible to damage. For example, when a peripheral device is inserted into the connector, the peripheral device protrudes from the electronic device and may be subjected to movement (accidental, intentional or otherwise) which may damage or disrupt the mechanical and/or electrical connection between the connector and the substrate.

To address the above, the present disclosure describes an interposer for supporting a vertically mounted connector. In an example, the interposer includes multiple sets of contacts on a top surface. The contacts are arranged and/or adapted to contact respective pins in the connector when the connector is vertically mounted on the interposer. A trace extends from each contact and extends through the interposer and is connected to a pad on a bottom surface of the interposer. The contacts, the traces and the pads are arranged in a fan-out configuration which reduces cross-talk and/or noise.

The interposer also includes a number of securement features that strengthen a mechanical connection between the connector and the interposer. For example, the interposer includes an alignment aperture and a securement aperture which are adapted to receive and secure an alignment prong and a securement prong that extend from the connector. When the connector has been secured to the interposer, the connector and the interposer are surface mounted on a PCB or substrate.

In accordance with the above, many technical benefits may be realized including, but not limited to, reducing or eliminating the risk of damage to a vertically mounted connector and increasing signal transmission capabilities without increasing the risk of cross-talk or interference between signals.

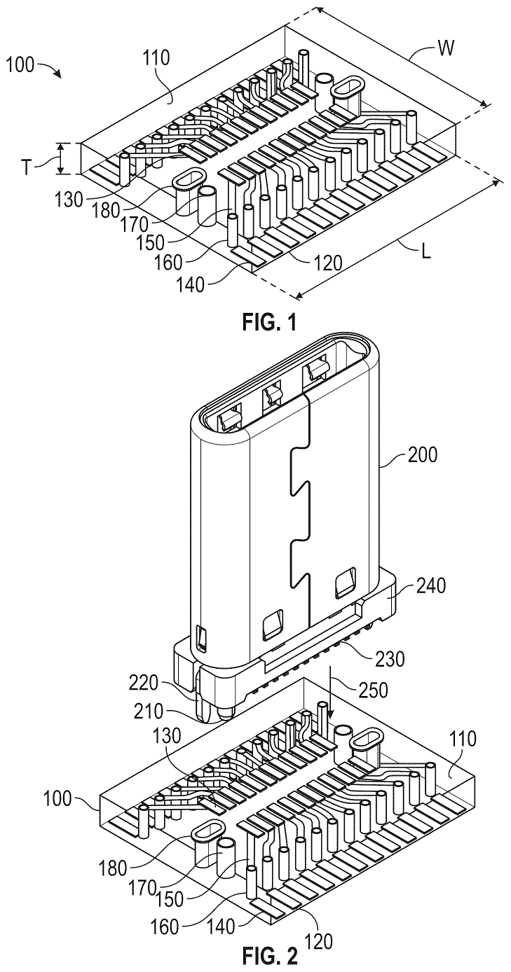

These benefits, along with other examples, will be shown and described in greater detail with respect to FIG. 1-FIG. 8.

FIG. 1 is an interposer 100 on which a connector may be vertically mounted according to an example. In an example and as will be explained in greater detail herein, the connector is a USB connector such as, for example, a USB Type-C (USB-C) connector. However, although a USB connector is specifically mentioned, the examples described herein may be applicable to a number of different ports or connectors.

In an example, the interposer 100 is a substrate or is comprised of a dielectric material. The interposer 100 includes a top surface 110 (or a first surface) and a bottom surface 120 (or a second surface) opposite the top surface 110. The top surface 110 and the bottom surface 120 define a thickness T of the interposer 100. In an example, the thickness of the interposer 100 is 1.3 millimeters (mm). Although a thickness is specifically mentioned, the interposer 100 may have any desired thickness.

The interposer 100 also has a length L and a width W. In an example, width of the interposer 100 is 8.4 mm and the length of the interposer 100 is 9.4 mm. Although specific dimensions are given, the interposer 100 may have any length and/or width.

A number of contacts 130 are provided on the top surface 110 of the interposer 100. In an example, the contacts 130 are gold finger contacts. Although gold finger contacts are specifically mentioned, the contacts 130 may be comprised of any materials.

In an example, the contacts 130 are divided into multiple sets and each set has a particular number of contacts 130. For example, a first set of twelve contacts 130 is provided at a first location (e.g., at or near a center portion) on the top surface 110 of the interposer 100. Additionally, a second set of twelve contacts 130 is provided at a second location (e.g., at or near the center portion and/or adjacent and/or near the first set of twelve contacts 130) on the top surface 110 of the interposer 100. Although twelve contacts are specifically mentioned in each set, the interposer 100 may have any number of contacts and/or any number of sets of contacts 130 at a variety of different locations.

The contacts 130 are separated from each other by a first distance or amount. The contacts 130 are spaced and/or are oriented to contact respective pins of a connector (such as will be described in greater detail with respect to FIG. 2) when the connector is mounted on the top surface 110 of the interposer 100. In an example, the distance at which the contacts 130 are separated from each other is uniform or substantially uniform. In other examples, the contacts 130 may have any suitable spacing so long as they align with respective pins of a connector.

The interposer 100 also includes a number of pads 140. The pads 140 are provided or positioned on the bottom surface 120 of the interposer. As shown in FIG. 1, the pads 140 are positioned at, near or proximate an edge of the length L of the interposer 100. However, it is contemplated that the pads 140 can be positioned at any location on the bottom surface 120 of the interposer 100. Regardless of the position and/or orientation, the pads 140 are coupled to corresponding pads on system in a package (SIP) substrate and/or a PCB on which the interposer 100 will be surface mounted.

The pads 140 are separated from each other by a second distance or amount. In an example, the second distance is greater than the first distance. Additionally, the pads 140 are spaced and/or are oriented to contact respective pads on a substrate or a PCB on which the interposer will be surface mounted. In an example, the distance at which the pads 140 are separated from each other is uniform or substantially uniform. In other examples, the pads 140 may have any suitable spacing so long as they align with respective pads of a substrate or PCB.

Each pad 140 is connected to a respective contact 130 using a trace 150, a wire, or other communication channel. In an example, each trace 150 is provided within an individual track within the interposer 100. The track helps prevent signal loss and/or cross-talk between the various signals that travel along each trace 150. In the example, the interposer 100 also includes vias 160 that enable each trace 150 to extend between a particular contact 130 and a particular pad 140.

As previously explained, the contacts 130 are separated from each other by a first distance and the pads 140 are separated from each other by a second distance. As a result, the contacts 130, the traces 150 and the pads 140 are arranged in a fan-out configuration. In an example, the fan-out configuration reduces signal reflections, crosstalk and other interference factors while enabling the small formfactor of the interposer 100 as well as providing high signal quality and integrity.

In an example, the interposer 100 also includes an alignment aperture 170. The alignment aperture 170 is defined on, in or by the top surface 110 of the interposer 100. The alignment aperture 170 is sized, spaced and/or positioned on the top surface 110 of the interposer 100 and is adapted and/or operable to receive an alignment prong of a connector when the connector is vertically mounted on the interposer 100. The alignment aperture 170 helps ensure that the various pins in the connector align with respective contacts 130.

The interposer 100 also includes a securement aperture 180. The securement aperture 180 is defined on, in or by the top surface 110 of the interposer 100. The securement aperture 180 is sized, spaced and/or positioned on the top surface 110 of the interposer 100 and is adapted and/or operable to receive a securement prong of the connector when the connector is coupled to the interposer 100. The securement aperture 180, along with the securement prong, help increase the mechanical stability of the vertically mounted connector when compared with current vertical mounting techniques that only use an epoxy or solder to secure the connector to a substrate.

FIG. 2 illustrates a connector 200 being vertically mounted to the interposer 100 of FIG. 1 according to an example. In an example, like reference numbers are intended to refer the various features discussed with respect to FIG. 1.

In the examples shown in FIG. 2, the connector 200 is a USB Type-C (USB-C) connector having twenty-four pins 230. Although a UBC-C connector having twenty-four pins 230 is specifically mentioned, the connector 200 may be any type of connect and have any number of pins 230.

In an example, the connector 200 includes an alignment prong 210 and a securement prong 220 that extend from a base 240 of the connector 200. In an example, the connector 200 includes multiple alignment prongs 210 and/or securement prongs 220 (e.g., on opposite sides of the base 240 of the connector 200). The alignment prong 210 is received within the alignment aperture 170 of the interposer 100 when the connector 200 is vertically mounted to the top surface 110 of the interposer 100 (shown by the arrow 250). The alignment prong 210 and the alignment aperture 170 help ensure that the pins 230 of the connector are aligned with the contacts 130 of the interposer 100.

The securement prong 220 is received within the securement aperture 180 of the interposer 100 when the connector 200 is vertically mounted to the top surface 110 of the interposer 100 (shown by the arrow 250). In an example, securement aperture 180 and/or the securement prong 220 includes a locking mechanism or shelf that secure the securement prong 220 within the securement aperture 180.

For example, a locking mechanism within the securement aperture 180 interfaces and/or receives a locking mechanism of the securement prong 220 which mechanically secures the base 240 of the connector 200 on the top surface 110 of the interposer 100. The securement aperture 180 and the securement prong 220 also secures and/or enhances (when compared with current solutions) contact between the pins 230 of the connector 200 and the contacts 130.

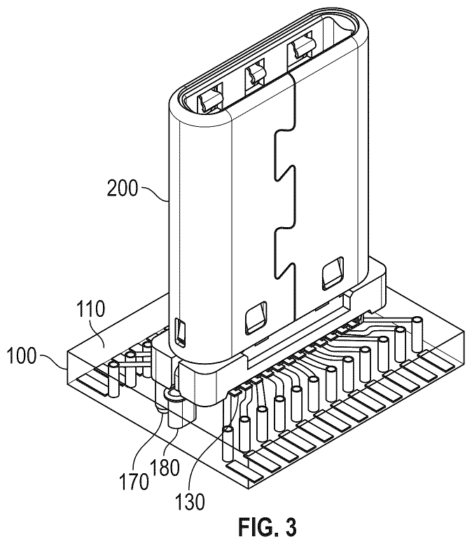

FIG. 3 illustrates the connector 200 of FIG. 2 being vertically mounted to the top surface 110 of the interposer 100 of FIG. 1 according to an example. As shown in FIG. 3, when the connector 200 has been coupled to the interposer 100, the alignment prong 210 (FIG. 2) of the connector 200 is received within the alignment aperture 170 of the interposer 100. Likewise, the securement prong 220 (FIG. 2) of the connector 200 is received within the securement aperture 180 of the interposer 100. Additionally, the pins 230 (FIG. 2) of the connector 200 contact or are otherwise communicatively and/or electrically coupled to the contacts 130 on the top surface 110 of the interposer 100.

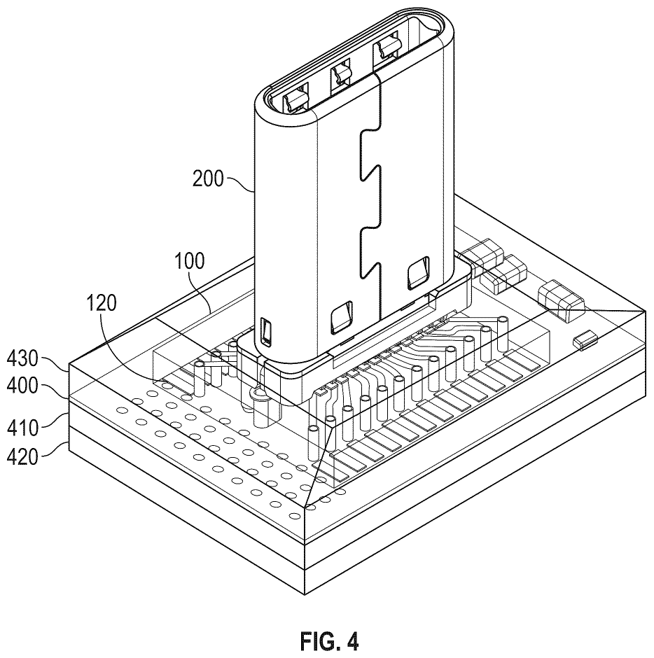

FIG. 4 illustrates the connector 200 and interposer 100 of FIG. 3 being surface mounted to a substrate 400 according to an example. In an example, interposer 100 is surface mounted to the substrate 400 after the connector 200 is vertically mounted to the interposer 100. In another example, the interposer 100 is surface mounted to the substrate 400 before the connector 200 is vertically mounted to the interposer 100. In an example, the interposer 100 is surface mounted to the substrate 400 using any suitable surface mounting technique.

The substrate 400 includes various pads that are arranged and/or positioned to contact the various pads on a surface of the substrate 400. In an example, the substrate 400 is part of a system in a package (SiP) that includes, additional layers 410 and 420. In an example, the additional layers 410 and 420 are mold compound layers that protect the SiP from electromagnetic interference and/or electrostatic discharge effects.

In an example, an epoxy layer 430 encases and/or surrounds the interposer 100 and at least a portion (e.g., the base 240 (FIG. 2) of the connector 200. The epoxy layer 430 provides additional mechanical support to the connector 200.

For example and as shown in FIG. 8, FIG. 8 illustrates a USB Type-C connector 800 according to the various examples described herein. In an example, the USB Type-C connector is an electronic device or is part of an electronic device.

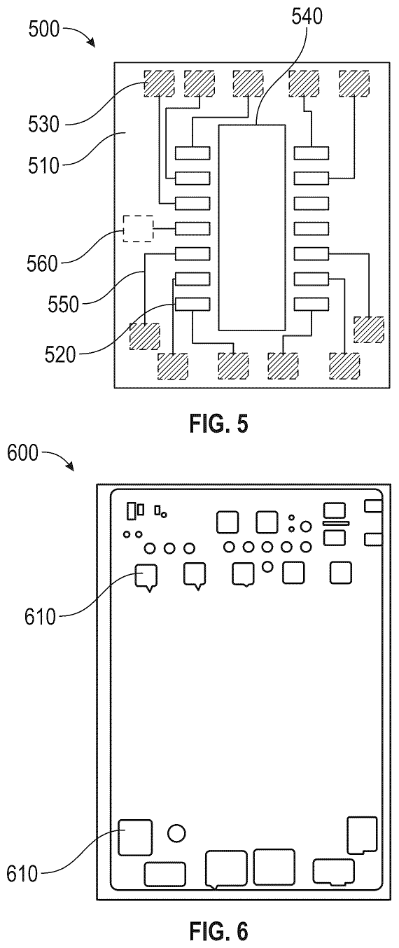

In the example shown, the USB Type-C connector 800 is vertically mounted to an interposer (e.g., the interposer 100 (FIG. 1) or the interposer 500 (FIG. 5)). At least a portion of the USB Type-C connector 800 and the interposer, along with various additional layers, SiPs, and/or substrates are enclosed within a housing 810 or shell. In an example, the housing 810 is similar to the epoxy layer 430 shown and described with respect to FIG. 4.

FIG. 5 illustrates an interposer 500 on which a connector may be vertically mounted according to another example. In an example, the interposer 500 may be similar to the interposer 100 shown and described with respect to FIG. 1. For example, a USB Type-C (USB-C) connector may be vertically mounted on, or otherwise connected to, the interposer 500. Although a USB connector is specifically mentioned, the examples described herein may be applicable to a number of different ports or connectors.

Like the interposer 100 shown and described with respect to FIG. 1, the interposer 500 is comprised of a substrate or a dielectric material. The interposer 500 includes a top surface 510 (or a first surface) and a bottom surface (or a second surface) opposite the top surface 510. The top surface 510 and the bottom surface define a thickness of the interposer 500. In an example, the interposer 500 may have any desired thickness and/or other desired dimensions.

The interposer 500 includes a number of contacts 520 provided on the top surface 510. In an example, the contacts 520 are gold finger contacts. In another example, the contacts 520 are solder pads. Although gold finger contacts and solder pads are specifically mentioned, the contacts 520 may be comprised of any type of material.

The contacts 520 are divided into multiple rows, groups or sets. In an example, each set has a particular number of contacts 520. For example, a first set contacts 520 is provided at a first location (e.g., at or near a center portion) on the top surface 510 of the interposer 500 and a second set of contacts 520 is provided at a second location on the top surface 510 of the interposer 500. For example, the second set of contacts 520 are located at or near the center portion and/or adjacent and/or near the first set of contacts 520. However, in some examples, the interposer 500 may have any number of contacts 520 at a variety of locations.

Like the contacts 130 shown and described with respect to FIG. 1, the contacts 520 are separated from each other by a first distance or amount. The contacts 520 are spaced and/or are oriented to contact respective pins of a connector (such as previously described) when the connector is mounted on the top surface 510 of the interposer 500. In an example, the distance at which the contacts 520 are separated is uniform or substantially uniform. In other examples, the contacts 520 have any suitable spacing so long as they align with respective pins of a connector when a connector is posited at and/or within a connector slot 540 provided on the top surface 510 of the interposer 500.

The interposer 500 also includes a number of pads 530. The pads 530 are provided or positioned on the bottom surface of the interposer 500. In an example, the pads 530 are positioned at various locations on the bottom surface of the interposer 500. For example, the pads 530 are positioned near or proximate various edges of the interposer 500.

The pads 530 are separated from each other by a second distance or amount. In an example, the second distance is greater than the distance at which the contacts 520 are separated. Additionally, the pads 530 are spaced and/or are oriented to contact respective pads on a substrate or a PCB on which the interposer 500 will be surface mounted.

For example and referring to FIG. 6, FIG. 6 illustrates a substrate 600 that is operable to receive the interposer 500 shown and described with respect to FIG. 5 according to an example. In an example, the substrate 600 includes a number of pads 610. The pads 610 are sized, spaced and/or positioned on the substrate 600 to receive corresponding pads (e.g., the pads 530) on the bottom surface of the interposer 500.

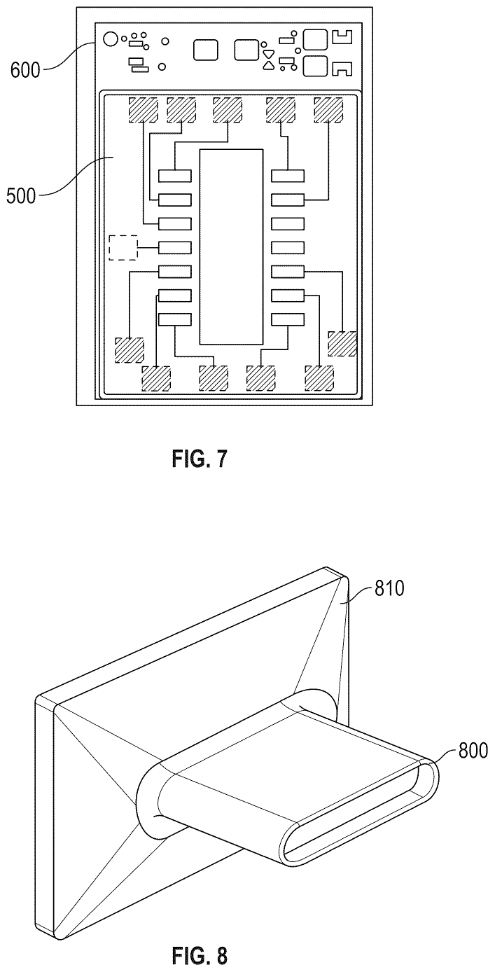

In an example, the substrate 600 is a system in a package (SiP) for connector that is different than the connector that will be mounted on the interposer 500. For example, the substrate 600 is used with a USB Type-A connector. However, the design and layout of the interposer 500 enables a USB Type-C connector to be mounted on, and used with, the Type-A substrate 600. For example and as shown in FIG. 7, FIG. 7 illustrates the interposer 500 of FIG. 5 being surface mounted to the substrate 600 of FIG. 6 according to an example.

Referring back to FIG. 5, one or more pads 530 are connected to one or more contacts 520 using a trace 550, a wire, or other communication channel. In an example, each trace 550 is provided within an individual track within the interposer 500. The track helps prevent signal loss and/or cross-talk between the various signals that travel along each trace 550. The interposer 500 may also include vias that enable each trace 550 to extend between a particular contact 520 and a particular pad 530.

As previously explained, the interposer 500 enables a USB Type-C connector to be mounted on a Type-A SiP. However, even though the dimensions of the interposer 500 may be based on the Type-A SiP keep out and footprint dimensions, the USB Type-C connector has an additional configurable conductor (CC) pin compared to USB Type-A connectors. Typically, the CC pin connects to a 5.1K pull-down resistor at the device side which helps detect when the USB-C connector is coupled to the device.

However, the Type-A SiP does not have a 5.1K pull-down resistor. In an example, this can be remedied by one of two approaches. In one example, a CC pad can be added to the substrate 600 (FIG. 6). However, when a USB Type-A connector is added to the substrate 600, the CC pin not be connected to anything. In another example, the interposer 500 includes a CC pin 560, a CC resistor or a CC pulldown mechanism as part of the design. For example, the CC pin 560 is integrated with the interposer 500.

In accordance with the various examples described herein, examples of the present disclosure describe an electronic device, comprising: a substrate; an interposer electrically coupled to the substrate and comprising: a plurality of contacts on a first surface, at least two of the plurality of contacts having a first spacing; a plurality of pads on second surface that is opposite the first surface, at least two of the plurality of pads having a second spacing that is greater than first spacing; and a plurality of traces, each trace of the plurality of traces extending between a respective contact of the plurality of contacts and a respective pad of the plurality of pads; and a connector vertically mounted on the interposer and having a plurality of pins, wherein each pin of the plurality of pins is electrically coupled to a respective contact of the plurality of contacts. In an example, the interposer further comprises an alignment aperture defined by the first surface. In an example, the connector further comprises an alignment prong that is received within the alignment aperture when the connector is vertically mounted on the interposer. In an example, the interposer further comprises a securement aperture defined by the first surface. In an example, the connector further comprises a securement prong that is received within the securement aperture when the connector is vertically mounted on the interposer, the securement prong and the securement aperture proving mechanical support for the connector. In an example, the plurality of contacts, the plurality of traces and the plurality of pads are arranged in a fan-out configuration. In an example, the interposer is surface mounted to a substrate configured for a type of connector that is different than the connector that is vertically mounted on the interposer. In an example, the electronic device includes a configurable conductor mechanism integrated with the interposer.

Examples also describe an interposer for vertically mounting a connector to a substrate, comprising: a first set of contacts on a first surface of the interposer and being oriented in a first direction; a second set of contacts on the first surface of the interposer and being oriented in a second direction, the first set of pins and the second set of pins adapted to contact respective pins of the connector; a first set of pads on a second surface of the interposer that is opposite the first surface of the interposer, the first set of pads being electrically coupled to the first set of contacts; and a second set of pads on the second surface of the interposer, the second set of pads being electrically coupled to the second set of contacts. In an example, a first set of traces electrically couple the first set of contacts and the first set of pads and wherein a second set of traces electrically couple the second set of contacts and the second set of pads. In an example, the first set of traces and the first set of pads are arranged in a fan-out configuration. In an example, the interposer also includes an alignment aperture defined by the first surface. In an example, the interposer also includes a securement aperture defined by the first surface. In an example, a configurable connector mechanism is integrated with the interposer.

Examples also describe an electronic device, comprising: a substrate; a connector support means electrically coupled to the substrate and comprising: a first set of contact means arranged at a first location on a first surface of the connector support means and having a first spacing; a second set of contact means arranged at a second location on the first surface of the connector support means and having the first spacing; a first set of connection means electrically coupled to the first set of contact means, the first set of connection means having a second spacing that is greater than the first spacing; and a second set of connection means electrically coupled to the second set of contact means, the second set of connection means having the second spacing; and a connector means vertically mounted on the connector support means and electrically coupled to the first set of contact means and the second set of contact means. In an example, the connector support means further comprises an alignment receiving means. In an example, the connector means further comprises an alignment means that is received within the alignment receiving means. In an example, the connector support means further comprises a securement receiving means. In an example, the electronic device also includes a pulldown means integrated with the connector support means. In an example, the first set of contact means, the second set of contact means, the first set of connection means and the second set of connection means are arranged in a fan-out configuration.

One of ordinary skill in the art will recognize that the technology described herein is not limited to a single specific memory structure, but covers many relevant memory structures within the spirit and scope of the technology as described herein and as understood by one of ordinary skill in the art.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an example with a particular set of features. Having been provided with the description and illustration of the present disclosure, one skilled in the art may envision variations, modifications, and alternate aspects falling within the spirit of the broader aspects of the general inventive concept embodied in this disclosure that do not depart from the broader scope of the claimed disclosure.

Aspects of the present disclosure have been described above with reference to schematic flowchart diagrams and/or schematic block diagrams of methods, apparatuses, systems, and computer program products according to examples of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. An electronic device, comprising:
a substrate;
an interposer electrically coupled to the substrate and comprising:
a plurality of contacts on a first surface, at least two of the plurality of contacts having a first spacing;
a plurality of pads on second surface that is opposite the first surface, at least two of the plurality of pads having a second spacing that is greater than first spacing; and
a plurality of traces, each trace of the plurality of traces extending between a respective contact of the plurality of contacts and a respective pad of the plurality of pads; and
a connector vertically mounted on the interposer and having a plurality of pins, wherein each pin of the plurality of pins is electrically coupled to a respective contact of the plurality of contacts.

2. The electronic device of claim 1, wherein the interposer further comprises an alignment aperture defined by the first surface.

3. The electronic device of claim 2, wherein the connector further comprises an alignment prong that is received within the alignment aperture when the connector is vertically mounted on the interposer.

4. The electronic device of claim 1, wherein the interposer further comprises a securement aperture defined by the first surface.

5. The electronic device of claim 4, wherein the connector further comprises a securement prong that is received within the securement aperture when the connector is vertically mounted on the interposer, the securement prong and the securement aperture providing mechanical support for the connector.

6. The electronic device of claim 1, wherein the plurality of contacts, the plurality of traces and the plurality of pads are arranged in a fan-out configuration.

7. The electronic device of claim 1, wherein the interposer is surface mounted to a substrate configured for a type of connector that is different than the connector that is vertically mounted on the interposer.

8. The electronic device of claim 1, further comprising a configurable conductor mechanism integrated with the interposer.

9. An interposer for vertically mounting a connector to a substrate, comprising:
a first set of contacts on a first surface of the interposer and being oriented in a first direction;
a second set of contacts on the first surface of the interposer and being oriented in a second direction, the first set of pins and the second set of pins adapted to contact respective pins of the connector;
a first set of pads on a second surface of the interposer that is opposite the first surface of the interposer, the first set of pads being electrically coupled to the first set of contacts; and
a second set of pads on the second surface of the interposer, the second set of pads being electrically coupled to the second set of contacts.

10. The interposer of claim 9, wherein a first set of traces electrically couple the first set of contacts and the first set of pads and wherein a second set of traces electrically couple the second set of contacts and the second set of pads.

11. The interposer of claim 9, wherein the first set of traces and the first set of pads are arranged in a fan-out configuration.

12. The interposer of claim 9, further comprising an alignment aperture defined by the first surface.

13. The interposer of claim 9, further comprising a securement aperture defined by the first surface.

14. The interposer of claim 9, further comprising a configurable connector mechanism integrated with the interposer.

15. An electronic device, comprising:
a substrate;
a connector support means electrically coupled to the substrate and comprising:
a first set of contact means arranged at a first location on a first surface of the connector support means and having a first spacing;
a second set of contact means arranged at a second location on the first surface of the connector support means and having the first spacing;
a first set of connection means electrically coupled to the first set of contact means, the first set of connection means having a second spacing that is greater than the first spacing; and
a second set of connection means electrically coupled to the second set of contact means, the second set of connection means having the second spacing; and
a connector means vertically mounted on the connector support means and electrically coupled to the first set of contact means and the second set of contact means.

16. The electronic device of claim 15, wherein the connector support means further comprises an alignment receiving means.

17. The electronic device of claim 16, wherein the connector means further comprises an alignment means that is received within the alignment receiving means.

18. The electronic device of claim 15, wherein the connector support means further comprises a securement receiving means.

19. The electronic device of claim 18, further comprising a pulldown means integrated with the connector support means.

20. The electronic device of claim 15, wherein the first set of contact means, the second set of contact means, the first set of connection means and the second set of connection means are arranged in a fan-out configuration.
